(19) United States
(12) Patent Application Publication
(10) Pub. No.: US 2016/0236501 A1
(43) Pub. Date: Aug. 18, 2016

(54) DISK-BOUND NOTEBOOK SYSTEM WITH SHEETS AND SHEETS THEREFOR

(71) Applicant: Continental Accessory Corporation, Amityville, NY (US)

(72) Inventor: Ronald Koeppel, Brookville, NY (US)

(21) Appl. No.: 14/833,443

(22) Filed: Aug. 24, 2015

Related U.S. Application Data
(60) Provisional application No. 62/117,148, filed on Feb. 17, 2015.

(51) Int. Cl. B42B 5/08; B42D 3/00; B42F 3/00

(52) U.S. Cl. CPC B42B 5/08; B42F 3/003; B42D 3/00

(57) ABSTRACT

A notebook system is disclosed. The notebook system includes a pair of covers, a stack of plural of sheets and a plurality of disks. Each of the disks is circular and has a generally planar central section and an enlarged peripheral rim. Each of the sheets has an inner edge portion including an inner edge and a plurality of slots spaced along the inner edge. Each of the slots includes an entryway channel extending inward from the inner edge and terminates at an enlarged opening. The inner edge portion of each sheet is reinforced by a reinforcing strip of material, e.g., a transparent plastic, extending along the inner edge. The slots extend into the reinforcing strip.

### CROSS-REFERENCE TO RELATED APPLICATIONS

This non-provisional application claims the benefit under 35 U.S.C. §119(e) of Provisional Application Ser. No. 62/117,148 filed on Feb. 17, 2015, entitled Disk-Bound Notebook System With Reinforced Sheets And Reinforced Sheets Therefor, the entire disclosure of that provisional application is hereby incorporated by reference herein.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISK

Not Applicable

### FIELD OF THE INVENTION

This invention relates generally to notebook systems and more particularly to notebook systems having removable pages.

### BACKGROUND OF THE INVENTION

Notebook systems making use of a stack of sheets is bound together using a plurality of disks are commercially available from various sources, including Continental Accessory, Corp., the assignee of the subject invention. Those notebook systems include a front cover, a rear cover, a plurality of disks and a stack of sheets, e.g., paper sheets. Each of the sheets and the covers include a plurality of mushroom-like shaped slots along one marginal edge thereof. Each of the slots is arranged to receive a respective disk to bind all of the sheets and covers together, so that the notebook serves as a binder with removable sheets.

U.S. Pat. No. 5,553,959 (Feldman et al.) and U.S. Pat. No. 5,749,667 (Feldman et al.) disclose notebook systems like the foregoing. In particular, the Feldman et al. systems make use of a stack of sheets is bound together between a front and rear cover using a plurality of disks that are inserted into mushroom shaped slots in the edge of each of the sheets of the stack and each of the covers. Each of the plural disks has a substantially flat disk-like central surface portion and an enlarged continuous rim portion which extends around the periphery of the central surface portion. The rim portion extends outwardly in a direction perpendicular to the flat central portions of the disks, and the central surface portion has a radius which is larger than the thickness of a stack of sheets to be bound thereby.

While such prior art notebook systems are generally suitable for their intended purposes, they leave something to be desired from the standpoint of susceptibility of the pages to become damaged upon repeated insertions in the notebook and removals from the notebook. Thus, a need exists for a notebook system having pages that are resistant to damage upon repeated insertion in the notebook and removal from the notebook. The subject invention addresses that need.

All references cited and/or identified herein are specifically incorporated by reference herein.

### SUMMARY OF THE INVENTION

In accordance with one aspect of this invention a sheet for use in a notebook system is provided. The notebook system comprises a pair of covers and a plurality of disks. Each of the disks is circular and has a generally planar central section and an enlarged peripheral rim. The sheet comprises a web of material having an inner edge portion. The inner edge portion includes an inner edge and a plurality of slots spaced along the inner edge. Each of the slots comprises an entryway channel extending inward from the inner edge and terminating at an enlarged opening. The inner edge portion is reinforced by a reinforcing strip of material extending along the inner edge. The slots extend into the reinforcing strip.

In accordance with one preferred embodiment of one aspect of this invention the strip of material is fixedly secured to one surface of the associated sheet at its inner edge portion.

In accordance with another aspect of this invention a notebook system is provided. The notebook system comprises a pair of covers, a stack of plural sheets and a plurality of disks. Each of the disks is circular and has a generally planar central section and an enlarged peripheral rim. Each of the sheets of the stack comprises a web of material having an inner edge portion. The inner edge portion includes an inner edge and a plurality of slots spaced along the inner edge. Each of the slots comprises an entryway channel extending inward from the inner edge and terminating at an enlarged opening. The inner edge portion is reinforced by a reinforcing strip of material extending along the inner edge. The slots extend into the reinforcing strip.

In accordance with another aspect of this invention a sheet for forming a page of a notebook system is provided. The notebook system comprises a pair of covers and a plurality of disks, each of the disks being circular and having a generally planar central section and an enlarged peripheral rim. The sheet comprising a web of material having an inner edge portion including an inner edge and a plurality of slots spaced along the inner edge, Each of the slots comprises an entryway channel extending inward from the inner edge and terminating at an enlarged opening. The channel extends inward from the inner edge generally perpendicular to the inner edge and wherein each of the enlarged openings comprises an inner end which is arcuate. The inner end has a pair of ends, each of which is generally linear and extends parallel to the channel to thereby form a slot which is somewhat mushroom-like in shape.

### DESCRIPTION OF THE DRAWING

FIG. 1 is top plan view of one exemplary embodiment of a sheet for use in a disk-bound notebook system constructed in accordance with this invention;

FIG. 2 is an enlarged sectional view taken along line 2-2 of FIG. 1;

FIG. 3 is an enlarged sectional view taken along line 3-3 of FIG. 1;

FIG. 4 is a reduced isometric view of a disk-bound notebook system making use of a stack of sheets constructed in accordance with this invention and like shown in FIG. 1; and

FIG. 5 is an enlarged view of the portion of the sheet shown within the broken line circle designated by the reference number 5 in FIG. 1.

### DETAILED DESCRIPTION OF THE PREFERRED EMBODIMENT

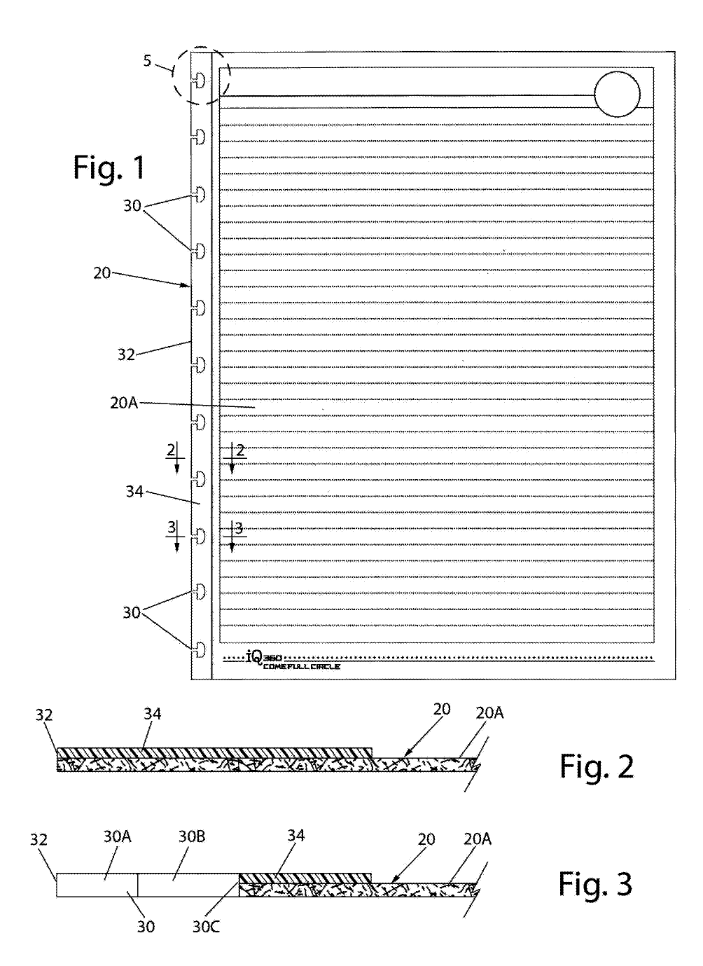

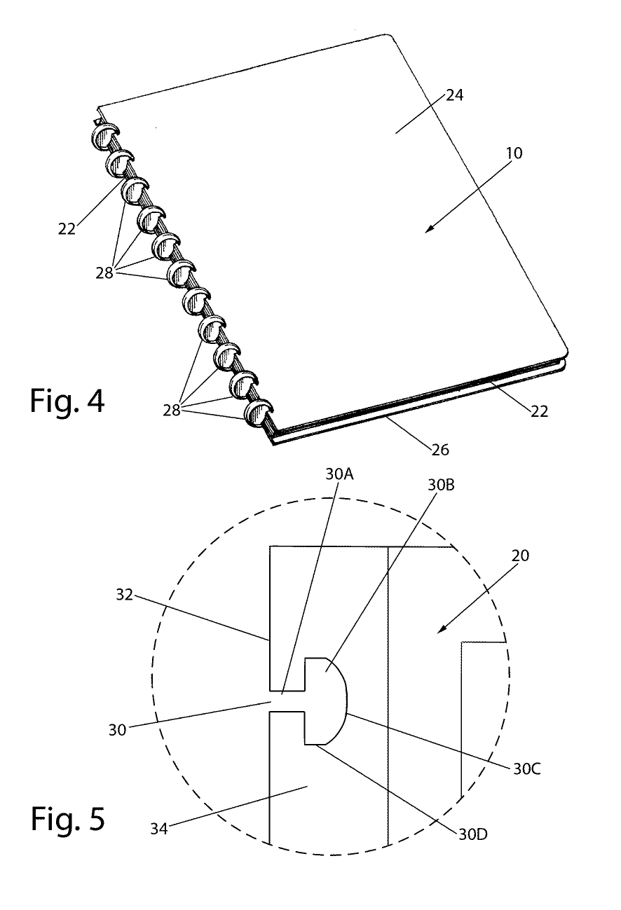

Referring now to the various figures of the drawing wherein like reference characters refer to like parts, there is shown at 20 in FIG. 1 one exemplary embodiment of a single sheet of a stack of sheets 22 (FIG. 4) making up a portion of a notebook system 10 (FIG. 4) constructed in accordance with this invention. The notebook system includes a top cover member 24, a bottom cover member 26 and a plurality of disks 28 releasably securing the stack of sheets 22 between the covers members 24 and 26. The sheets 20 will be described in more detail later. Suffice it for now to state that each sheet is formed of a web of any suitable material, e.g., paper, and includes a marginal edge portion having a plurality of generally mushroom-like shaped slots 30 equidistantly located therealong. The cover members 24 and 26 are each generally planar members formed of any suitable material, e.g., cardboard, leather, polypropylene, etc. Like the sheets 20, the covers also include a marginal edge portion having a plurality of generally mushroom-like shaped slots 30 equidistantly located therealong. Each of the slots of the covers and each of the slots of the sheets 20 of the stack 22 interposed between the covers are arranged to receive a respective one of the plurality of disks 28 to bind the covers and the sheets together to form a notebook with replaceable/removable pages. To that end, after the assembly of the notebook, the sheets 20 can be turned or flipped individually or in groups relative to the notebook.

The slots 30 are best seen in FIG. 5 and basically each comprises an entryway or channel 30A which extends inward from the edge 32 of the sheet 20 and is perpendicular to that inner edge. Each channel 30A terminates at an enlarged opening 30B. The opening 30B has an inner end 30C which is arcuate, with each end 30D of the inner end being generally linear and extending parallel to the channel 30A to thereby form a slot which is somewhat mushroom-like in shape.

As mentioned above each of the disks 28 is arranged to be received in a respective slot 30. Thus, the disks 28 are circular and are of a cross-section which is shaped to mate with the slots. In particular, the periphery of each disk comprises an enlarged continuous rim portion extending around the entire periphery of the disk member, with the rim portion having shape corresponding to the shape of the opening 30B of the slot 30. The central section of each disk is planar and is of a thickness slightly less than the width of the channel 30A so that it can be received within the channel, when the rim of the disk is within the associated enlarged opening 30B.

As can be seen clearly in FIGS. 1-3 the marginal edge of each of the sheets 20 encompassing the slots 30 is reinforced to ensure that the sheet is resistant to damage when it is inserted into the notebook or removed from the notebook. To that end, each sheet 20 includes a strip of reinforcement 34 secured to the sheet contiguous with the inner edge 32. In the exemplary embodiment shown herein the reinforcement strip 34 is a thin layer of a plastic material, such as but not limited to a liquid lamination coating, a thin layer of Mylar, foil, paper, metal or fiberglass, which is fixedly secured to the upper surface 20A of the sheet. Preferably the plastic material is transparent, but could be opaque and/or colored in the interest of aesthetics. In any case, it should be noted that the foregoing arrangement of the reinforcing strip is merely exemplary. Thus, it is contemplated that the strip 34 may be on the lower surface of the sheet or on both surfaces. Moreover, the reinforcing strip 34 may be formed of other materials than the exemplary plastic material.

It should also be pointed out that the sheets and the covers need not be shaped like that shown herein, provided that the edge of the sheet making up the slots is reinforced. For example, any or all of the sheets 20 of the stack can be constructed to include an edge portion having slots that are reinforced in accordance with this invention, and a portion adjacent that edge portion in the form of a pocket for receipt of some item therein. To that end, the sheets may be constructed of a transparent material forming a pocket into which an item, such as a letter, a stamp, or any other flat, “keep-sake” item can be disposed, so that the notebook system can be used a scrap-book or a means for organizing and filing of papers. Other types of sheets may be constructed in accordance with this invention, providing that they are reinforced along the edge at which the mounting slots 30 are located.

Without further elaboration the foregoing will so fully illustrate my invention that others may, by applying current or future knowledge, adopt the same for use under various conditions of service.

I claim:

1. A sheet for forming a page of a notebook system, the notebook system comprising a pair of covers and a plurality of disks, each of the disks being circular and having a generally planar central section and an enlarged peripheral rim, said sheet comprising a web of material having an inner edge portion, said inner edge portion including an inner edge and a plurality of slots spaced along said inner edge, each of said slots comprising an entryway channel extending inward from said inner edge and terminating at an enlarged opening, said inner edge portion being reinforced by a reinforcing strip of material extending along said inner edge, said slots extending into said reinforcing strip.

2. The sheet of claim 1 wherein the said reinforcing strip is fixedly secured to one surface of said sheet at said inner edge portion.

3. The sheet of claim 1 wherein said reinforcing strip is formed of a material selected from the group consisting of plastic, Mylar, foil, paper, metal and fiberglass.

4. The sheet of claim 2 wherein said reinforcing strip is formed of a material selected from the group consisting of plastic, Mylar, foil, paper, metal and fiberglass.

5. The sheet of claim 3 wherein said sheet is formed of paper.

6. The sheet of claim 4 wherein said sheet is formed of paper.

7. The sheet of claim 1 wherein said sheet comprises a stack of similar sheets arranged to be releasably mounted between the covers by the plurality of disks.

8. The sheet of claim 1 wherein said channel extends inward from said inner edge generally perpendicular to said inner edge and wherein each of said enlarged openings comprises an inner end which is arcuate, said inner end having a pair of ends, each of which is generally linear and extends parallel to said channel to thereby form a slot which is somewhat mushroom-like in shape.

9. The sheet of claim 7 wherein said channel extends inward from said inner edge generally perpendicular to said inner edge and wherein each of said enlarged openings comprises an inner end which is arcuate, said inner end having a pair of ends, each of which is generally linear and extends parallel to said channel to thereby form a slot which is somewhat mushroom-like in shape.

10. A notebook system comprising a pair of covers, a plurality of sheets and a plurality of disks, each of said disks being circular and having a generally planar central section and an enlarged peripheral rim, each of said sheets comprising a web of material having an inner edge portion including an inner edge and a plurality of slots spaced along said inner edge, each of said slots comprising an entryway channel extending inward from said inner edge and terminating at an enlarged opening, said inner edge portion being reinforced by a reinforcing strip of material extending along said inner edge, said slots extending into said reinforcing strip.

11. The notebook system of claim 10 wherein the said reinforcing strip is fixedly secured to one surface of said sheet at said inner edge portion.

12. The notebook system of claim 10 wherein said reinforcing strip is formed of a material selected from the group consisting of plastic, Mylar, foil, paper, metal and fiberglass.

13. The notebook system of claim 11 wherein said reinforcing strip is formed of a material selected from the group consisting of plastic, Mylar, foil, paper, metal and fiberglass.

14. The notebook system of claim 12 wherein said sheet is formed of paper.

15. The notebook system of claim 13 wherein said sheet is formed of paper.

16. The notebook system of claim 10 wherein said sheet comprises a stack of similar sheets arranged to be releasably mounted between the covers by the plurality of disks.

17. The notebook system of claim 10 wherein said channel extends inward from said inner edge generally perpendicular to said inner edge and wherein each of said enlarged openings comprises an inner end which is arcuate, said inner end having a pair of ends, each of which is generally linear and extends parallel to said channel to thereby form a slot which is somewhat mushroom-like in shape.

18. The sheet of claim 16 wherein said channel extends inward from said inner edge generally perpendicular to said inner edge and wherein each of said enlarged openings comprises an inner end which is arcuate, said inner end having a pair of ends, each of which is generally linear and extends parallel to said channel to thereby form a slot which is somewhat mushroom-like in shape.

19. A sheet for forming a page of a notebook system, the notebook system comprising a pair of covers and a plurality of disks, each of the disks being circular and having a generally planar central section and an enlarged peripheral rim, said sheet comprising a web of material having an inner edge portion, said inner edge portion including an inner edge and a plurality of slots spaced along said inner edge, each of said slots comprising an entryway channel extending inward from said inner edge and terminating at an enlarged opening, wherein said channel extends inward from said inner edge generally perpendicular to said inner edge and wherein each of said enlarged openings comprises an inner end which is arcuate, said inner end having a pair of ends, each of which is generally linear and extends parallel to said channel to thereby form a slot which is somewhat mushroom-like in shape.

20. The sheet of claim 19 wherein said sheet comprises a stack of similar sheets arranged to be releasably mounted between the covers by the plurality of disks.
